(19) United States
(12) Patent Application Publication
(10) Pub. No.: US 2014/0055498 A1
(43) Pub. Date: Feb. 27, 2014

(54) METHOD FOR SCALING VIDEO DATA, AND AN ARRANGEMENT FOR CARRYING OUT THE METHOD

(71) Applicant: Alexander Neubeck, Obermichelbach (DE)

(72) Inventor: Alexander Neubeck, Obermichelbach (DE)

(73) Assignee: Robert Bosch GmbH, Stuttgart (DE)

(21) Appl. No.: 14/115,485

(22) PCT Filed: Apr. 30, 2012
(86) PCT No.: PCT/EP2012/057878

§ 371 Date: Nov. 14, 2013

(30) Foreign Application Priority Data
May 4, 2011 (DE) 10 2011 075 261.7

(51) Int. Cl. G06T 3/40

(52) U.S. Cl. CPC G06T 3/40
USPC 345/660

(57) ABSTRACT

The invention presents a method for editing video data (60), a method for presenting video data (60) and an arrangement for carrying out the method for editing video data (60). The method for editing video data (60) involves the video data (60) being smoothed and sampled in a CPU (50) for presenting and then transmitted to a graphics card having a graphics processor (52), in which the prescaled video data (64) are subjected to an edge sharpening operation.

### BACKGROUND OF THE INVENTION

The invention relates to a method for processing video data, a method for representing video data, and an arrangement for carrying out the method for processing the video data.

Graphics cards are used for controlling the on-screen display in computing systems or computers. Usually, when executing a program, the processor or the CPU of the computing system calculates the data and forwards them to the graphics card. The graphics card converts the data in such a way that the monitor can reproduce the data as an image.

Usually, video data are either prescaled completely on the central processing unit (CPU) and then transmitted to the graphics card or the complete video image is transmitted to the graphics card and scaled to the target resolution there.

In video surveillance systems, a very large number of video sequences have to be represented in parallel on a monitor. If the intention is to represent e.g. 25 HD videos (resolution e.g. 1280×720) at 60 Hz, then 1500 textures have to be transmitted to the graphics card, which corresponds to a transfer rate of two Gbytes/second. In order to be able to represent the 25 HD videos with full resolution on the monitor, the latter would have to have a total resolution of 6400×3600. However, high-definition monitors generally have a significantly lower maximum resolution of e.g. 1920×1200 pixels. If the video material was scaled on the CPU by means of a traditional method, then a transfer rate of 207 Mbytes/second would suffice. However, this procedure has the disadvantage that the CPU, which is already occupied with decoding and other tasks, must also carry out the video scaling. High-quality image scaling by an arbitrary scaling factor is, however, a complex operation for the CPU.

The document DE 10 2005 046 664 A1 describes a method for producing a flexible display region for a video surveillance system. In this case, the display region comprises a main window, into which a number of information windows can be inserted. A changeover of an operator is effected by selecting and changing the size of an information window. The method described realizes a human-machine interface which offers a clear representation in conjunction with a good possibility of adaptation to the respective application. In this case, video information is graphically conditioned, arranged and represented in such a way that it is possible for the information to be optimally transmitted to the human operator.

The so-called scaling problem has to be taken into consideration in the representation of video data. In digital image processing, scaling denotes the change in size of a digital image, a distinction being drawn between raster graphics and vector graphics. The scaling of raster graphics constitutes a sampling rate conversion, namely the conversion of a discrete signal at one sampling rate into a discrete signal at another sampling rate.

### SUMMARY OF THE INVENTION

Against this background, a method for processing video data comprising the features of claim 1, a method for representing video data as claimed in claim 5 and an arrangement as claimed in claim 6 are presented. Configurations are evident from the dependent claims and the description.

The method presented thus makes it possible to distribute the load arbitrarily between CPU and graphics card, such that the available resources can be optimally utilized.

The method presented is concerned with the decomposition of the general scaling problem consisting of two steps: a smoothing operation including sampling and a subsequent edge sharpening operation. The former can be realized particularly efficiently on the CPU by means of SSE instructions (SSE: streaming SIMD extension) if scaling by a power of 2 or at least an integral factor is effected. In the example mentioned above, ideally the image material is prescaled by the CPU by a factor of 2 in both directions, i.e. is correspondingly smoothed and sampled. This reduces the volume of data to be transmitted by a factor of 4. Afterward, on the graphics card, the edge sharpening is carried out and the result image is typically brought to the final target resolution in the context of a final scaling by the remaining 5/3 factor.

A smoothing operation in this case should be understood to mean in the mathematical context an operation by which a curve is converted into a curve having a smaller curvature. This curve having a smaller curvature is intended to deviate as little as possible from the original curve.

Since the decoded image usually has to be held in the main memory as a reference image, the image should be copied into a specific texture memory for the transmission. Ideally, the image smoothing including sampling replaces the simple copying operation.

It should be taken into consideration that a modern compression standard, during the coding of a data frame or frame, references other frames. These frames have to be efficiently accessible by the decoder and, if the decoder is implemented on the CPU, are present in the main memory of the computer. In order that the graphics card driver can copy the frame from the main memory into the graphics card memory efficiently by DMA, the frame has to be present in a specific area of a non-swappable memory or in a pinned memory area.

An application should be very conservative in handling pinned memory since the latter cannot be swapped by the operating system to make space for other applications including the operating system. In order therefore to satisfy both areas, the decoder area and the texture upload area, a copying operation from normal memory to a pinned memory area is necessary. From the pinned memory area, the data are then copied by DMA transfer to the memory of the graphics card and can then be accessed for further calculations and representations.

This is designated herein as a “simple” copying operation since apart from the copying no further transformation takes place. However, this copying operation is done by the CPU or the processor, that is to say that the processor reads a small data area into its register and writes the content thereof to a different address. Therefore, the capacity of the processor is not utilized to an excessively great extent and in addition the processor can also calculate simple transformations, such as e.g. the smoothing and undersampling of the image.

With corresponding optimization and selection of the scaling method, the additional operations are negligible, and so the conversion does not give rise to a further load for the CPU. The subsequent texture transfer relieves the load on the graphics card bus or memory bus by a factor of 4 in the present example, that is to say that only 500 Mbytes/second are transferred.

The remaining edge sharpening and further scaling can be parallelized line by line and/or column by column very well, which makes them particularly suitable for processing on modern graphics cards by means of CUDA (Compute Unified Device Architecture) or compute shaders. CUDA denotes a technique enabling the development of program parts which are processed by the graphics processor (GPU) on the graphics card.

In this case, total load is likewise reduced compared with complete scaling on the graphics card despite the additional edge sharpening, since the volume of data has already been reduced by a factor of 4 by the CPU. The advantage becomes even clearer in the case of greater scalings, for example in the case of Full HD 1920×1020, since then the first scaling step on the CPU already enables a reduction of data by a factor of 16 without producing a significant load on the CPU.

Further advantages and configurations of the invention are evident from the description and the accompanying drawings.

It goes without saying that the features mentioned above and those yet to be explained below can be used not only in the combination respectively indicated, but also in other combinations or by themselves, without departing from the scope of the present invention.

### BRIEF DESCRIPTION OF THE DRAWINGS

FIG. 1 shows an embodiment of the arrangement described.

FIG. 2 shows an embodiment of the method presented.

### DETAILED DESCRIPTION

The invention is illustrated schematically on the basis of embodiments in the drawings and is described in detail below with reference to the drawings.

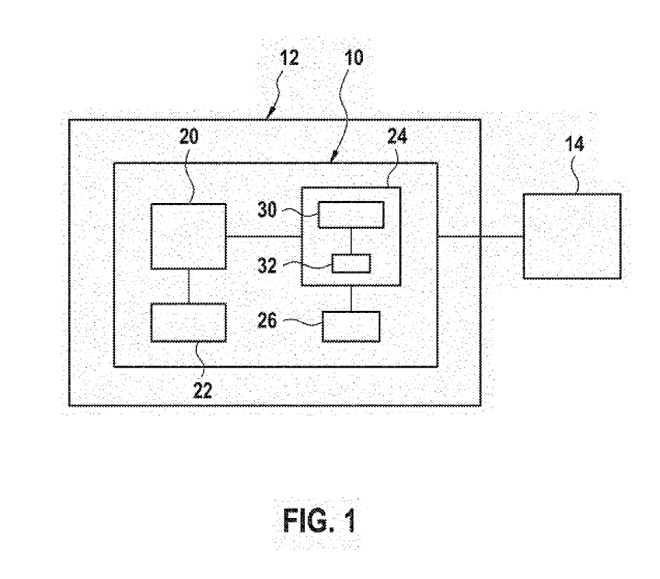

FIG. 1 shows a schematic illustration of an embodiment of the arrangement presented, which is designated overall by the reference numeral 10 and is integrated in a computing system or a computer 12. This arrangement 10 is connected to a monitor 14, on which video data are intended to be represented.

The arrangement 10 comprises a CPU 20, a main memory 22, a graphics card 24 and a texture memory 26. A graphics processor 30 and a graphics memory 32 are in turn provided in the graphics card 24. In one embodiment of the arrangement 10, the graphics memory 32 serves as a texture memory 26.

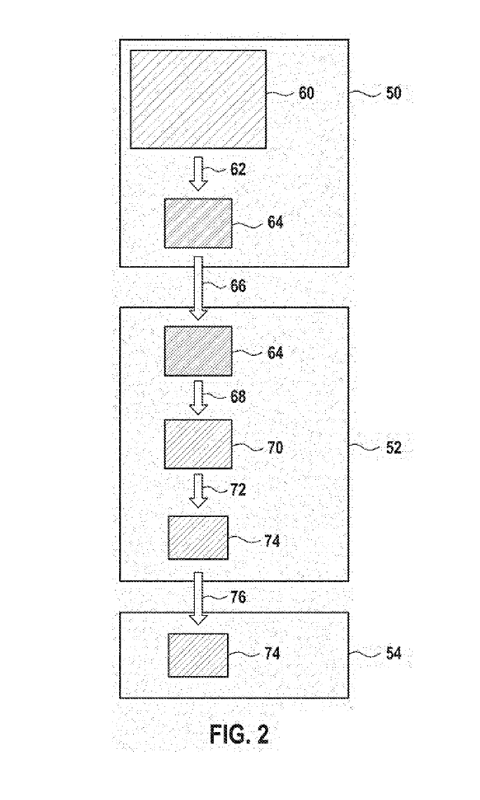

In FIG. 2, the method presented is reproduced on the basis of the conversion of the video data provided for representation. For this purpose, the illustration shows a CPU 50, a graphics processor 52 and a monitor 54.

At the beginning, the video data 60 provided for representation are present in the CPU 50. In a first step 62, the video data 60 are smoothed and sampled, with the result that prescaled video data 64 are present. In a further step 66, these prescaled video data 64 are transmitted by means of texture transfer to the graphics processor 52. In the graphics processor 52, the prescaled video data 64 are subjected to an edge sharpening operation in a further step 68, with the result that edge-sharpened prescaled video data 70 are present. The edge-sharpened prescaled video data 70 are subjected to a final scaling in a further step 72, as a result of which finally scaled video data 74 are obtained. These finally scaled video data 74 are transmitted to the monitor 54 for presentation or representation in a concluding step 76.

It has been recognized that the general scaling problem corresponds to a change of basis, i.e. the original image, i.e. the original video data 60, is projected into the target space in a manner as free from losses as possible. If discrete input signals are employed, then “freedom from losses” can be measured as reproduction error, i.e. the original pixels are reproduced by the scaled image by interpolation and the deviation with respect to said original pixels is measured. In the continuous case, a measure is defined which compares the two continuous signals directly with one another, e.g.:

<f, g>=Integral f(x)*g(x) dx

For the sake of simplicity, the method is described below on the basis of the discrete variant. However, the method presented can likewise be applied to the continuous case.

In many cases, the scaling task is replaced by a simple interpolation task on account of the complexity and the resulting severe aliasing effects or instances of unsharpness are accepted in favor of the performance capability. The method described shows how the correct scaling can be carried out without impairing the performance capability.

Mathematically, the discrete scaling problem can be formulated as follows:

(A*y−x)̂2−>min
where x represents the original image, y represents the scaled image and A represents an interpolation matrix in order to arrive at the original image again from the scaled image.

This scaling problem has the following solution:

y=(ÂT*A)̂−1*ÂT*x

In the above notation, ÂT corresponds to the smoothing operation with sampling and (ÂT*A)̂−1 corresponds to the edge sharpening.

In the case of scaling by an integral factor and given suitable boundary conditions, e.g. in the case of a mirroring, A corresponds to a convolution matrix, which can be calculated by means of simple convolution. Therefore, ÂT and (ÂT*A)̂−1 are likewise convolution matrices. The latter can be calculated by means of z-transformation or matrix decomposition by means of simple recursive filters.

Since image scaling in the x- and y-directions are independent of one another, the corresponding operations can also be mixed arbitrarily. It is therefore appropriate to carry out first the operations which reduce the volume of data to the greatest extent, i.e. in the case of image scaling firstly to carry out the corresponding smoothing with sampling in the x- and y-directions, before beginning the edge or image sharpening. In combination with a graphics card, this means that the CPU performs the simple convolution with corresponding data reduction both in the x-direction and in the y-direction, while the graphics card carries out the corresponding post-processing in order to arrive at the final scaled image. The data transfer between main memory and graphics card is automatically minimized with this scheme.

1. A method for processing video data which are to be represented on a monitor, the method comprising:
smoothing and sampling the video data in a CPU for prescaling; and
transmitting the prescaled data to a graphics card having a graphics processor, in which the prescaled video data are subjected to an edge sharpening operation.

2. The method as claimed in claim 1, wherein the prescaled video data are transmitted by means of texture transfer.

3. The method as claimed in claim 1, wherein, in addition to the edge sharpening operation, a final scaling is carried out in the graphics processor.

4. The method as claimed in claim 3, wherein the edge sharpening operation and the final scaling are parallelized line by line and/or column by column.

5. A method for representing video data on a monitor, wherein the video data are processed by a method as claimed in claim 1 before being represented.

6. An arrangement for processing video data, which has a CPU and a graphics card having a graphics processor, wherein the CPU is designed for smoothing and sampling the video data for the purpose of prescaling the video data and the graphics processor is designed for an edge sharpening operation of the prescaled video data.

7. The arrangement as claimed in claim 6, wherein a texture memory is provided for the transmission of the prescaled video data.

8. The arrangement as claimed in claim 7, wherein a graphics memory of the graphics card serves as the texture memory.

9. The arrangement as claimed in claim 6, wherein an SSE instruction data set is stored in the CPU.

10. The arrangement as claimed in claim 6, wherein the CPU and the graphics card are integrated in a computing system.
